(19) United States
(12) Patent Application Publication
(10) Pub. No.: US 2026/0274345 A1
(43) Pub. Date: Sep. 17, 2026

(54) FRONT HOOD LATCH DEVICE

(71) Applicant: MITSUI KINZOKU ACT CORPORATION, Yokohama-shi, Kanagawa (JP)

(72) Inventor: Minetaka KATAGAWA, Kanagawa (JP)

(73) Assignee: MITSUI KINZOKU ACT CORPORATION, Yokohama-shi, Kanagawa (JP)

(21) Appl. No.: 19/469,813

(22) PCT Filed: Sep. 8, 2023
(86) PCT No.: PCT/JP2023/032815

§ 371 Date: Sep. 26, 2025

(30) Foreign Application Priority Data
Mar. 30, 2023 (JP) 2023-055514
Mar. 30, 2023 (JP) 2023-055515

(51) Int. Cl. B62D 25/12; E05B 77/54; E05B 81/20; E05B 83/24

(52) U.S. Cl. CPC B62D 25/12; E05B 77/54; E05B 81/20; E05B 83/243

(57) ABSTRACT

A front hood latch device includes a latch on a vehicle body, engageable with a striker on a front hood; an energizing member that biases the latch toward a release position; a primary pole configured to engage the latch at a primary latch position to hold the hood fully closed; a secondary pole configured to engage the latch at a secondary latch position to hold the hood partially closed; and an actuator unit operable to release the primary pole from the latch. Further, the actuator unit operates to release the primary pole upon receiving an open command only when the vehicle is stopped. The actuator unit remains inoperative if the open command is received while the vehicle is traveling, preventing the hood from opening.

### FIELD

The present disclosure relates to front hood latch devices and particularly relates to a front hood latch device that performs opening and closing control of a front hood for opening and closing a front trunk provided at the front of a vehicle body.

### BACKGROUND

In some vehicles such as electric vehicles or rear engine vehicles in which the engine is mounted at the rear of a vehicle body, the front of the vehicle body is used as a front trunk. In this type of vehicle, two latch mechanisms are provided so that the front hood is not inadvertently opened during traveling and, the two latch mechanisms are released only when the vehicle is stopped (see, for example, Patent Literature 1).

### CITATION LIST

### Patent Literature

Patent Literature 1: U.S. Unexamined Patent Application Publication No. 2022-0162887

### SUMMARY

A front hood latch device according to the present disclosure includes: a latch provided in a body of a vehicle, the latch meshable with a striker at a front portion of a front hood when the front hood is closed; an energizing member that energizes the latch in a direction of releasing the meshing; a primary pole that maintains the front hood in a fully closed position by being engaged with the latch in a state where the latch engaged with the striker is disposed in a predetermined primary latch position; a secondary pole that maintains the front hood at a half-hooked position by being engaged with the latch in a case where the latch released from an engagement state with the primary pole is disposed at a predetermined secondary latch position; and an actuator unit capable of releasing the engagement state between the primary pole and the latch when the actuator unit operates in an opening direction. Further, the actuator unit is operated in the opening direction in a case where an open command is given while the vehicle is stopped, and the actuator unit is maintained in a halted state in a case where an open command is given while the vehicle is traveling.

According to the present disclosure, the above front hood latch device further includes: an in-front trunk operation transmission unit that causes the primary pole to operate in a direction of releasing the engagement state with the latch in a case where an in-front trunk operation unit is operated, the in-front trunk operation unit provided inside the front trunk that can be opened and closed by the front hood. Further, in the case where the primary pole operates in the direction of releasing the engagement state with the latch, the secondary pole is caused to operate in a direction of releasing the engagement state with the latch on condition that the vehicle is stopped.

According to the present disclosure, the above front hood latch device further includes an in-vehicle operation transmission unit that causes the secondary pole to operate in the direction of releasing the engagement state with the latch in a case where an in-vehicle operation unit provided in a cabin is operated. Further, the in-vehicle operation unit is provided at a position where it cannot be operated in a state where the vehicle is traveling.

According to the present disclosure, the above front hood latch device further includes: an in-vehicle operation transmission unit that causes the secondary pole to operate in the direction of releasing the engagement state with the latch in a case where an in-vehicle operation unit provided in a cabin is operated. Further, the in-vehicle operation transmission unit has a transmission switch unit that switches between an ON state in which an operation of the in-vehicle operation unit can be transmitted to the secondary pole and an OFF state in which an operation of the in-vehicle operation unit cannot be transmitted to the secondary pole, and the transmission switch unit enters the ON state only in a case where the vehicle is not traveling.

According to the present disclosure, the above front hood latch device further includes a close operation transmission unit that causes the latch to operate toward a primary latch position in a case where the actuator unit operates in a closing direction in a state where the latch is disposed in the secondary latch position.

According to the present disclosure, in the above front hood latch device, the actuator unit is caused to operate in the closing direction on condition that the latch is disposed in the secondary latch position by moving in the closing direction from a state in which the front hood is opened and that the secondary pole is engaged with the latch.

According to the present disclosure, in the above front hood latch device, an interlocking link unit is provided between the primary pole and the secondary pole, the interlocking link unit interlocking either the primary pole or the secondary pole in a case where the other one operates in the direction of releasing the engagement with the latch.

According to the present disclosure, in the above front hood latch device, the interlocking link unit comprises a link bar that interlocks the primary pole and the secondary pole, and the link bar interlocks the primary pole to move in the direction of releasing the engagement state with the latch in a case where the secondary pole operates in the direction of releasing the engagement state with the latch and, in a case where the primary pole operates in the direction of releasing the engagement state with the latch, maintains the secondary pole in a state of being engaged with the latch.

According to the present disclosure, the above front hood latch device further includes an open operation transmission unit that causes the secondary pole to operate in the direction of releasing the engagement state with the latch in a case where the actuator unit operates in the opening direction.

According to the present disclosure, in the above front hood latch device, a housing member accommodating the latch includes a guide portion along a movement path of the close operation transmission unit.

According to the present disclosure, the above front hood latch device further includes a cancel unit that releases the engagement state between the close operation transmission unit and the latch in a case where an operation force for emergency use is input.

According to the present disclosure, in the above front hood latch device, the cancel unit includes a cancel lever that operates integrally with the secondary pole.

According to the present disclosure, in the above front hood latch device, the actuator unit comprises a drive source and a deceleration mechanism, the deceleration mechanism is disposed at a position where at least a component overlaps the latch in an operation axis direction of the latch, an output unit of the drive source and an output unit of the deceleration mechanism are arranged at positions around the latch in the operation axis direction of the latch, a circuit board on which a controller for controlling an operation of the actuator unit is mounted is disposed between the output unit of the drive source and the output unit of the deceleration mechanism in an operation axis direction of the latch and at a position overlapping the latch, the primary pole, and the secondary pole, and the circuit board is provided with a state detection sensor that detects states of the latch, the primary pole, and the secondary pole.

### Advantageous Effects of Disclosure

According to the present disclosure, a primary pole and a secondary pole that are engaged with a latch are included, and operating a command transmission unit such as a key FOB releases the engagement state between the primary pole and the latch by the operation of an actuator unit on condition that a vehicle is stopped. As a result, even if the command transmission unit is operated while the vehicle is traveling, there is no possibility that the front hood is unintentionally opened, and the safety can be secured with improved operability.

### BRIEF DESCRIPTION OF THE DRAWINGS

FIG. 1 is a perspective view of a front hood latch device according to an embodiment of the present disclosure as viewed from a base plate side.

FIG. 2 is a perspective view of the front hood latch device illustrated in FIG. 1 as viewed from a cover side.

FIG. 3 is a front perspective view of a vehicle to which the front hood latch device illustrated in FIG. 1 is applied.

FIG. 4 is a diagram illustrating an internal structure of the front hood latch device illustrated in FIG. 1 with the cover and the case omitted.

FIG. 5 is a diagram in which a cinching lever and a cancel lever are omitted in FIG. 4.

FIG. 6 is a diagram of arrangement positions of a latch, a primary pole, a secondary pole, a link bar, a cancel lever, and an open lever in the front hood latch device illustrated in FIG. 1 as viewed from the base plate side.

FIG. 7 is a perspective view of FIG. 6.

FIG. 8 is a diagram illustrating an actuator unit applied to the front hood latch device illustrated in FIG. 1.

FIG. 9 is a perspective view of the case applied to the front hood latch device illustrated in FIG. 1.

FIG. 10 is a block diagram illustrating a control system of the front hood latch device illustrated in FIG. 1.

FIG. 11 is a flowchart illustrating the content of processing performed by a controller illustrated in FIG. 10.

FIG. 12 is a flowchart illustrating the content of cinching processing illustrated in FIG. 11.

FIG. 13 is a flowchart illustrating the content of open processing illustrated in FIG. 11.

FIG. 14 is a flowchart illustrating the content of emergency processing illustrated in FIG. 11.

FIG. 15 is a timing chart illustrating operation timings of a latch sensor, a primary pole sensor, a secondary pole sensor, a motor neutral sensor, and the motor rotation direction in the cinching processing illustrated in FIG. 11.

FIG. 16 is a timing chart illustrating operation timings of the latch sensor, the primary pole sensor, the secondary pole sensor, the motor neutral sensor, and the motor rotation direction in the open processing illustrated in FIG. 11.

FIG. 17A is a diagram sequentially illustrating the operation of the front hood latch device in the cinching processing illustrated in FIG. 11, in which the latch is in a meshing standby state.

FIG. 17B is a diagram sequentially illustrating the operation of the front hood latch device in the cinching processing illustrated in FIG. 11 and illustrating a state in which a striker has entered a striker approach groove.

FIG. 17C is a diagram sequentially illustrating the operation of the front hood latch device in the cinching processing illustrated in FIG. 11 and illustrating a state in which the striker has entered the striker approach groove.

FIG. 17D is a diagram sequentially illustrating the operation of the front hood latch device in the cinching processing illustrated in FIG. 11 and illustrating a state in which an open lever is rotated in the cinching direction.

FIG. 17E is a diagram sequentially illustrating the operation of the front hood latch device in the cinching processing illustrated in FIG. 11 and illustrating a state in which the primary pole is engaged with the latch.

FIG. 17F is a diagram sequentially illustrating the operation of the front hood latch device in the cinching processing illustrated in FIG. 11 and illustrating a state in which the open lever has recovered to a neutral position.

FIG. 18A is a diagram sequentially illustrating the operation of the front hood latch device in the open processing illustrated in FIG. 11 and illustrating a state where the latch engaged with the striker is in a primary latch position.

FIG. 18B is a diagram sequentially illustrating the operation of the front hood latch device in the open processing illustrated in FIG. 11 and illustrating a state in which the open lever has rotated in a release direction.

FIG. 18C is a diagram sequentially illustrating the operation of the front hood latch device in the open processing illustrated in FIG. 11 and illustrating a state in which the secondary pole has rotated in a direction of releasing the engagement state with the latch.

FIG. 18D is a diagram sequentially illustrating the operation of the front hood latch device in the open processing illustrated in FIG. 11 and illustrating a state in which the latch and the striker are disengaged from each other.

FIG. 18E is a diagram sequentially illustrating the operation of the front hood latch device in the open processing illustrated in FIG. 11 and illustrating a state in which the open lever has recovered to the neutral position.

FIG. 19A is a conceptual diagram illustrating the operation of a transmission switch unit provided in a transmission path from an in-vehicle operation unit to the secondary pole and illustrates an ON state.

FIG. 19B is a conceptual diagram illustrating the operation of the transmission switch unit provided in the transmission path from the in-vehicle operation unit to the secondary pole and illustrates an OFF state.

FIG. 19C is a conceptual diagram illustrating the operation of the transmission switch unit provided in the transmission path from the in-vehicle operation unit to the secondary pole and illustrates the OFF state.

### DESCRIPTION OF EMBODIMENTS

Hereinafter, preferred embodiments of a front hood latch device according to the present disclosure will be described in detail with reference to the accompanying drawings.

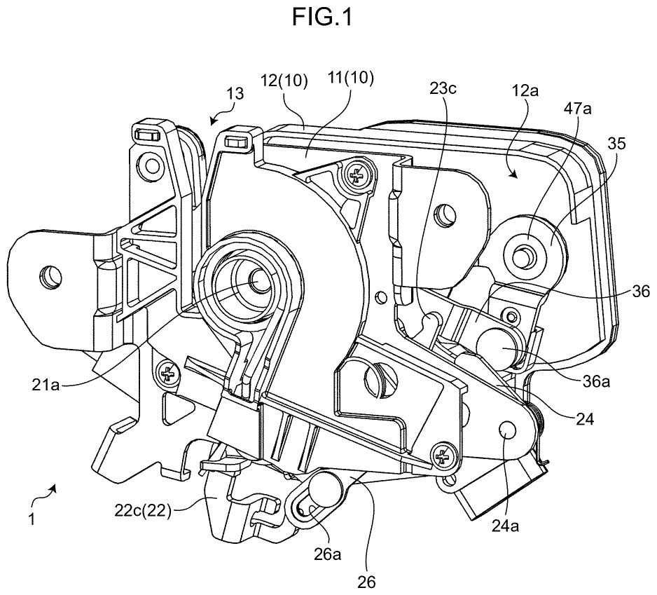

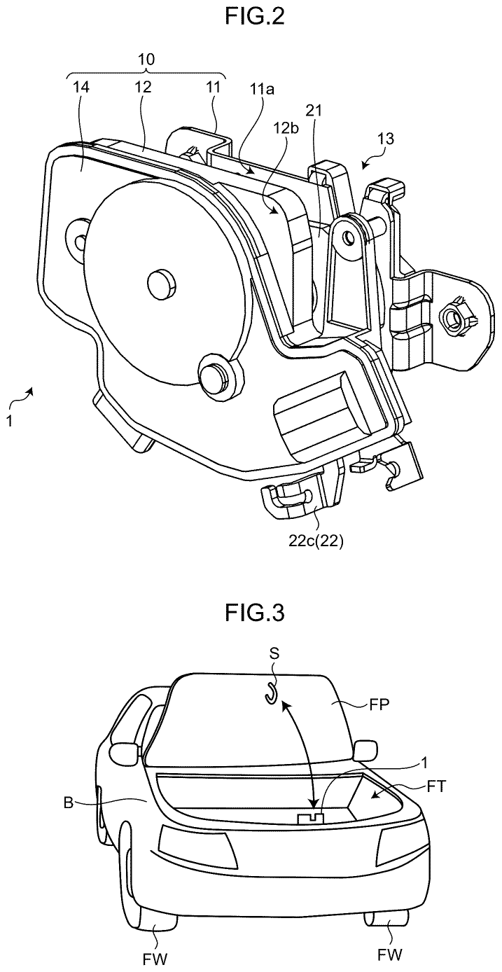

FIGS. 1 and 2 are diagrams illustrating a front hood latch device 1 according to an embodiment of the present disclosure. As illustrated in FIG. 3, the front hood latch device 1 illustrated as an example here is applied to a four-wheeled vehicle such as an electric vehicle including a front trunk (which may also be referred to as a frunk FT hereinafter) between the left and right front wheels FW at the front of the vehicle body B and performs opening and closing control of a front hood FP that opens and closes an upper opening of the frunk FT. In the present embodiment, a striker S is provided at a lower portion of the front edge of the front hood FP. The front hood latch device 1 performs control to maintain the front hood FP in a closed state or to open the frunk FT with respect to the vehicle body B by switching between a state of being engaged with the striker S and a state of being disengaged from the striker S. Hereinafter, a specific structure of the front hood latch device 1 will be described in detail. In the following description, for the sake of convenience, each direction is specified in an attitude of being mounted on the vehicle body B.

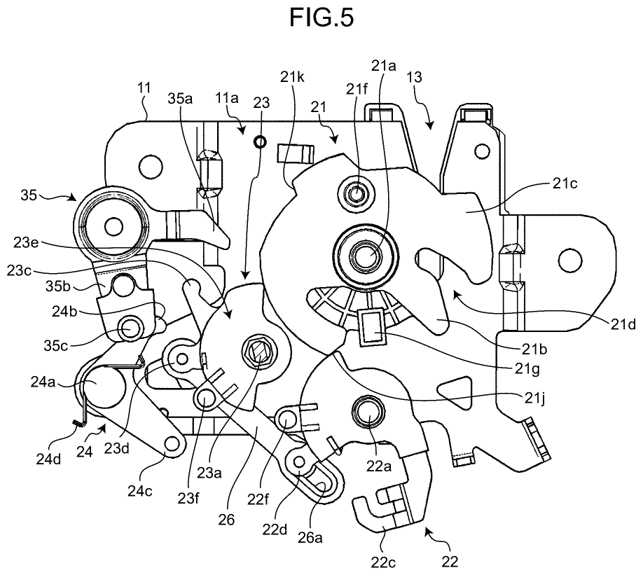

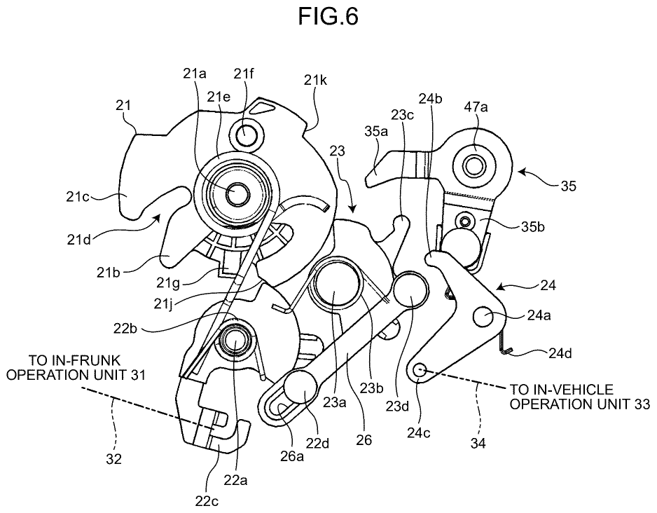

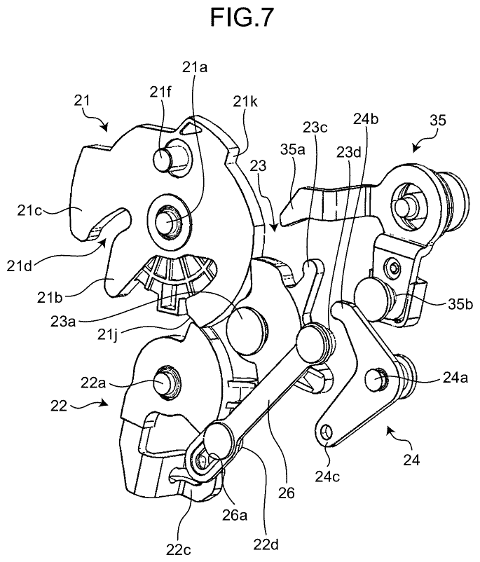

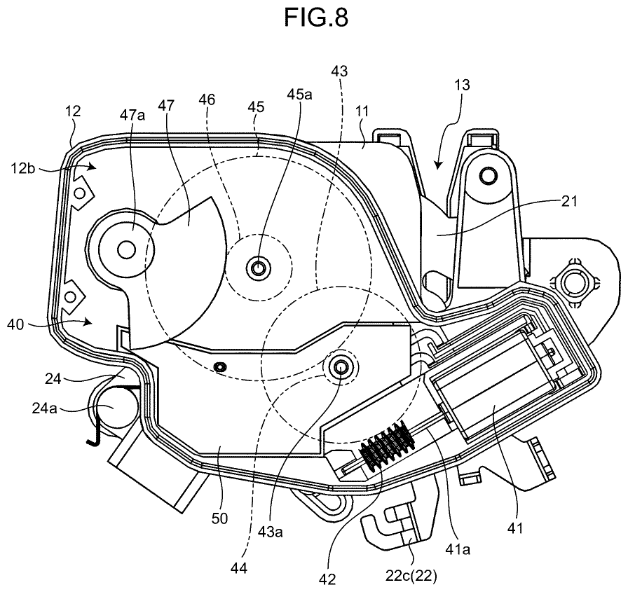

As illustrated in FIGS. 2 and 4 to 9, the front hood latch device 1 includes a latch 21, a primary pole 22, a secondary pole 23, an emergency lever 24, and a cancel lever 25 inside a housing member 10. The housing member 10 includes a base plate 11, a case 12, and a cover 14. The base plate 11 has a plate shape formed of a steel material. The case 12 is formed of resin and is structured such that an inner surface 12a covers one surface 11a of the base plate 11. The cover 14 is for covering an actuator unit 40 described later. In the base plate 11 and the case 12, a striker approach groove 13 is formed on one side of an upper portion. The striker approach groove 13 is a notch into which the striker S enters when the front hood FP is closed with respect to the frunk FT, extends in the up-down direction, and is formed to open at upper edges of the base plate 11 and the case 12. The dimensions of the striker approach groove 13 have a length that allows the front hood FP to be disposed at a fully closed position with respect to the frunk FT.

The latch 21, the primary pole 22, the secondary pole 23, and the emergency lever 24 are supported on the base plate 11 via respective support shafts and can rotate about axes parallel to each other. In the illustrated example, the support shaft of the latch 21 (hereinafter, referred to as a latch shaft 21a) is provided at a portion that is on a side of the striker approach groove 13. The support shaft of the primary pole 22 (hereinafter, referred to as a primary shaft 22a) is provided below the latch shaft 21a around the latch 21, and the support shaft of the secondary pole 23 (hereinafter, also referred to as a secondary shaft 23a) is provided between the latch shaft 21a and the primary shaft 22a around the latch 21. The support shaft of the emergency lever 24 (hereinafter, referred to as an emergency support shaft 24a) is provided at substantially the same height as the secondary shaft 23a at a position away from the latch 21 than the secondary shaft 23a is. The cancel lever 25 is provided at an edge of the secondary shaft 23a closer to the case 12 than to the secondary pole 23 and can rotate integrally with the secondary pole 23.

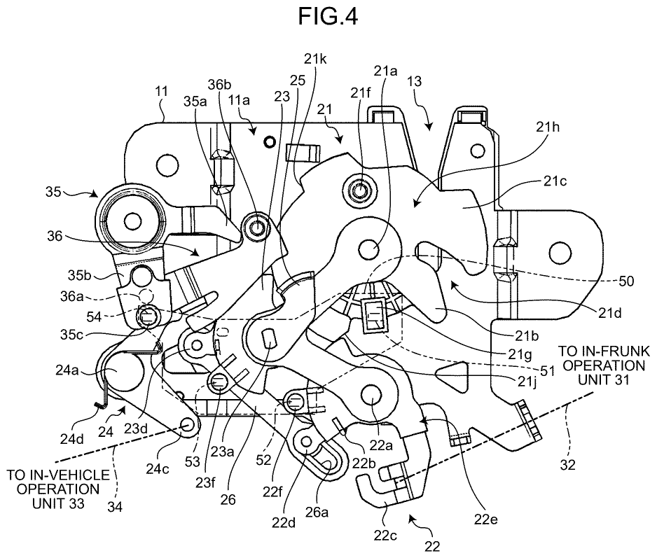

The latch 21 engages with the striker S and has a striker abutment portion 21b and a hook portion 21c on an outer peripheral portion thereof. The striker abutment portion 21b and the hook portion 21c extend in the radial direction from the latch shaft 21a, thus can be arranged in such a manner as to cross the striker approach groove 13 of the base plate 11, and are adjacent to each other in a state where an accommodation groove 21d capable of accommodating the striker S is secured therebetween. The latch 21 is constantly energized in the release direction (counterclockwise direction in FIG. 4) in such a manner as to return to a predetermined meshing standby state by the urging force of a latch spring (energizing member) 21e provided between the latch 21 and the base plate 11. The meshing standby state is a state in which the hook portion 21c is retracted laterally with respect to the striker approach groove 13 with the striker abutment portion 21b disposed at a position crossing the striker approach groove 13, and the opening of the accommodation groove 21d coincides with the striker approach groove 13. Therefore, in the meshing standby state, in a case where the front hood FP is closed, the striker S can enter the striker approach groove 13. When the front hood FP further moves in the closing direction, the striker S having entered the striker approach groove 13 abuts against the striker abutment portion 21b, whereby the latch 21 rotates in the meshing direction (clockwise direction in FIG. 4) against the urging force of the latch spring 21e, and the hook portion 21c is disposed in a state of crossing the open end side of the striker approach groove 13 in a state where the striker S is accommodated in the accommodation groove 21d.

The latch 21 is provided with a latch pin 21f and a latch detection magnet 21g. The latch pin 21f protrudes from a surface of the latch 21 on a side facing the case 12 (hereinafter, referred to as a case facing surface 21h) toward the case 12 and is provided above the latch shaft 21a at the time when the latch 21 is disposed in a primary latch position. The primary latch position of the latch 21 is a position where the hook portion 21c is disposed to cross the striker approach groove 13 in a state where the accommodation groove 21d of the latch 21 is positioned below the striker approach groove 13. The latch detection magnet 21g is for detecting the rotation state of the latch 21 by a magnet sensor to be described later. In the illustrated example, the latch detection magnet 21g is attached to a portion corresponding to the latch pin 21f across the latch shaft 21a on the case facing surface 21h of the latch 21, namely, a portion that is positioned below the latch shaft 21a when the latch 21 is disposed at the primary latch position.

Each of the primary pole 22 and the secondary pole 23 is engaged with the latch 21, thereby blocking the rotation of the latch 21 in the release direction against the urging force of the latch spring 21e to stop at a desired position.

Explaining more specifically, the primary pole 22 is structured to prevent the latch 21 from rotating in the release direction by being engaged with a primary engagement portion 21j of the latch 21 in a case where the latch 21 is disposed in the primary latch position. A primary spring 22b that constantly energizes the primary pole 22 in an engagement direction is provided between the primary pole 22 and the base plate 11. The primary pole 22 is provided with a frunk cable connection portion 22c. The frunk cable connection portion 22c extends in a radial direction with an extending end extending to a position beyond the base plate 11. The frunk cable connection portion 22c is connected with a frunk cable (in-front trunk operation transmission unit) 32 that is linked with an in-frunk operation unit (in-front trunk operation unit) 31. The in-frunk operation unit 31 is an operation part that can be operated from the inside of the frunk FT in a state where the front hood FP is closed. In a case where the in-frunk operation unit 31 is operated, the operation force is transmitted to the primary pole 22 via the frunk cable 32, and the primary pole 22 can be rotated in the direction of releasing the engagement state with the latch 21 against the urging force of the primary spring 22b.

The secondary pole 23 is structured to be engaged with a secondary engagement portion 21k of the latch 21 to prevent the latch 21 from rotating in the release direction in a case where the hook portion 21c is disposed in a state of crossing the striker approach groove 13 (secondary latch position of the latch 21) in a state where the accommodation groove 21d of the latch 21 is positioned above the striker approach groove 13.

In a case where the latch 21 is disposed at the primary latch position in a state where the striker S is accommodated in the accommodation groove 21d, the front hood FP is disposed at the fully closed position with respect to the frunk FT. In a case where the latch 21 is disposed at the secondary latch position in a state where the striker S is accommodated in the accommodation groove 21d, the front hood FP is disposed at a position slightly opened with respect to the frunk FT (half-hooked position of the front hood FP). Between the secondary pole 23 and the base plate 11, a secondary spring 23b that constantly energizes the secondary pole 23 in the engagement direction is provided. The secondary pole 23 is provided with an actuator input portion 23c. The actuator input portion 23c abuts on an open lever 35 when the open lever 35 to be described later rotates in the release direction (clockwise direction in FIG. 4) and rotates the secondary pole 23 in the direction of releasing the engagement state with the latch 21 against the urging force of the secondary spring 23b.

A link bar (interlocking link unit) 26 is provided between the primary pole 22 and the secondary pole 23. The link bar 26 interlocks the primary pole 22 when the secondary pole 23 rotates in the direction of releasing the engagement with the latch 21 and interlocks in such a manner to maintain the state in which the secondary pole 23 is engaged with the latch 21 when the primary pole 22 rotates in the direction of releasing the engagement state with the latch 21. In the illustrated example, one end of the link bar 26 is rotatably and axially supported by a lever link portion 23d of the secondary pole 23, and the other end of the link bar 26 is rotatably and axially supported by a lever link portion 22d of the primary pole 22 via a long hole 26a. The lever link portion 23d of the secondary pole 23 protrudes radially outward from the outer peripheral surface of the secondary pole 23, and the lever link portion 22d of the primary pole 22 protrudes radially outward from the outer peripheral surface of the primary pole 22. In the illustrated example, the lever link portion 23d is provided in such a manner as to extend substantially horizontally from the outer peripheral surface facing the emergency lever 24 in a state where the secondary pole 23 is in contact with the outer peripheral surface of the latch 21, and the lever link portion 22d is provided in such a manner as to extend obliquely downward from the outer peripheral surface facing the emergency lever 24 in a state where the primary pole 22 is in contact with the outer peripheral surface of the latch 21.

Similarly to the latch 21, a case facing surface 22e of the primary pole 22 is provided with a primary detection magnet 22f for detecting the rotation state of the primary pole 22 by a magnet sensor to be described later, and a case facing surface 23e of the secondary pole 23 is provided with a secondary detection magnet 23f for detecting the rotation state of the secondary pole 23 by the magnet sensor to be described later.

The emergency lever 24 includes a pole pressing portion 24b and a cabin cable connection portion 24c. Each of the pole pressing portion 24b and the cabin cable connection portion 24c extends in the radial direction from the emergency support shaft 24a. A lever spring 24d is provided between the emergency lever 24 and the base plate 11. The lever spring 24d energizes the emergency lever 24 in the counterclockwise direction in FIG. 4 to be disposed at a predetermined operation standby position. In a case where the emergency lever 24 is disposed at the operation standby position, the pole pressing portion 24b is disposed above the lever link portion 23d of the secondary pole 23 abutting against the outer peripheral surface of the latch 21, and in a case where the emergency lever 24 rotates clockwise in FIG. 4 against the urging force of the lever spring 24d, the pole pressing portion 24b abuts on the lever link portion 23d, whereby the secondary pole 23 can be rotated in the release direction. An emergency cable (in-vehicle operation transmission unit) 34 that links with an in-vehicle operation unit (operation unit for emergency use) 33 is connected with the cabin cable connection portion 24c. The in-vehicle operation unit 33 is provided at a position in the cabin which cannot be operated in a state where the vehicle is traveling, such as at the back on the floor of the driver's seat. In a case where the in-vehicle operation unit 33 is operated, the operation force is transmitted to the secondary pole 23 via the emergency cable 34, and the secondary pole 23 can be rotated in a direction of releasing the engagement state with the latch 21 against the urging force of the secondary spring 23b.

In a case where the secondary pole 23 is engaged with the latch 21, the cancel lever 25 extends from the secondary shaft 23a toward the latch shaft 21a and then bends upward. An extending edge of the cancel lever 25 has an arc shape and is thicker than the proximal end.

Meanwhile, the case 12 is provided with the actuator unit 40, the open lever (open motion transmission unit) 35, and a circuit board 50.

The actuator unit 40 includes an electric motor (drive source) 41 that can rotate forward and backward and a deceleration mechanism that decelerates the drive of the electric motor 41 and transmits the decelerated drive to the open lever 35. The actuator unit 40 is disposed on an outer surface 12b of the case 12. As the deceleration mechanism, a mechanism including a worm gear 42 provided on an output shaft 41a of the electric motor 41, a first gear (worm wheel) 43 meshed with the worm gear 42, a third gear 45 meshed with a second gear 44 integrally provided with the first gear 43, and a sector gear 47 meshed with a fourth gear 46 integrally provided with the third gear 45 is applied. The first gear 43 and the third gear 45 are rotatably supported by the case 12 via respective support shafts 43a and 45a parallel to the latch shaft 21a. In the illustrated example, the electric motor 41 is disposed on a radially outer side with respect to the latch 21, and the first gear 43 and the third gear 45 are arranged at positions overlapping the case facing surface 21h of the latch 21. The sector gear 47 is rotatably supported by the case 12 via a cylindrical boss portion (output portion) 47a provided at the center. The boss portion 47a of the sector gear 47 is provided above the emergency support shaft 24a on a radially outer side of the latch 21 in such a manner as to be parallel to the emergency support shaft 24a.

As illustrated in FIGS. 4 to 9, the open lever 35 is fixed to the boss portion 47a of the sector gear 47, rotates integrally with the sector gear 47, and includes a pressing lever portion 35a and a cinching connection portion 35b on the inner surface 12a side of the case 12.

The pressing lever portion 35a extends in the radial direction from the rotation axis of the open lever 35 and then is bent toward the base plate 11, and an extending edge is further bent and extends in a direction orthogonal to the rotation axis of the open lever 35. In a case where the open lever 35 is disposed at a predetermined neutral position, the pressing lever portion 35a is positioned above the actuator input portion 23c included in the secondary pole 23. When the electric motor 41 rotates in the opening direction from the neutral position, the open lever 35 rotates in the release direction (clockwise direction in FIG. 4) and rotates the secondary pole 23 in the direction of releasing the engagement state with the latch 21 via the actuator input portion 23c.

The cinching connection portion 35b extends in the radial direction from the rotational axis of the open lever 35. In a case where the open lever 35 is disposed at the neutral position, the cinching connection portion 35b extends downward from the rotation axis of the open lever 35. A cinching lever (close operation transmission unit) 36 is rotatably connected to the cinching connection portion 35b via a cinching support shaft 36a. The cinching support shaft 36a extends in parallel with the rotation axis of the open lever 35. The cinching lever 36 extends from the cinching connection portion 35b toward the latch pin 21f of the latch 21 between the case facing surface 21h of the latch 21 and the case 12 and includes a guide pin 36b at a distal end. The guide pin 36b extends from the cinching lever 36 toward the case 12. A guide rib (guide portion) 12c is included on the inner surface 12a of the case 12. The guide rib 12c guides the movement of the cinching lever 36 via the guide pin 36b when the open lever 35 rotates and is molded integrally with the case 12. In the present embodiment, the guide rib 12c is included so that the latch 21 can be rotated to the primary latch position against the urging force of the latch spring 21e by bringing an extending end surface of the cinching lever 36 into contact with the latch pin 21f when the open lever 35 rotates in the cinching direction (counterclockwise direction in FIG. 4).

In a case where the extending end surface of the cinching lever 36 abuts on the latch pin 21f and the latch 21 is disposed at the primary latch position, the extending edge of the cancel lever 25 closely faces the lower surface of the cinching lever 36. Therefore, when the secondary pole 23 rotates in the release direction from this state, the cinching lever 36 rotates counterclockwise in FIG. 4, whereby the abutting state with the latch pin 21f is released. An open lever detection magnet 35c for detecting the attitude of the open lever 35 by the magnet sensor to be described later is provided at the extending edge of the cinching connection portion 35b.

The circuit board 50 is provided at a position between the electric motor 41 and the open lever 35 on the outer surface 12b of the case 12. In the illustrated example, the circuit board 50 having a size that accommodates all the portions provided with the latch detection magnet 21g, the primary detection magnet 22f, the secondary detection magnet 23f, and the open lever detection magnet 35c is applied and is arranged at a position overlapping the latch 21, the primary pole 22, and the secondary pole 23 in the axial direction of the latch shaft 21a. The magnet sensor (state detection sensor) is disposed on the circuit board 50. The magnet sensor detects the latch detection magnet 21g, the primary detection magnet 22f, the secondary detection magnet 23f, and the open lever detection magnet 35c via the case 12.

More specifically, the magnet sensor that detects whether or not the latch 21 is in the primary latch position (hereinafter, referred to as a latch sensor 51) is provided in a corresponding manner to the latch detection magnet 21g. A magnet sensor corresponding to the primary detection magnet 22f (hereinafter, referred to as a primary pole sensor 52) detects whether or not the primary pole 22 is engaged with the latch 21, and a magnet sensor corresponding to the secondary detection magnet 23f (hereinafter, referred to as a secondary pole sensor 53) detects whether or not the secondary pole 23 is engaged with the latch 21. A magnet sensor (Hereinafter, referred to as a motor neutral sensor 54.) corresponding to the open lever detection magnet 35c detects whether or not the open lever 35 is in the neutral position. Although not clearly illustrated in the drawing, a processing device such as a central processing unit (CPU) included in a controller 100 to be described later, or hardware such as an integrated circuit (IC) is mounted on the circuit board 50.

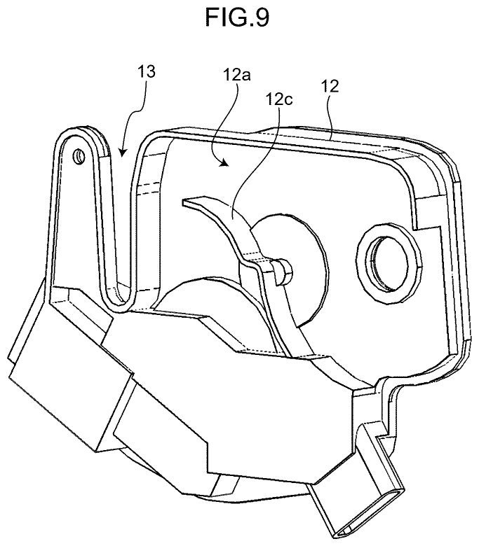

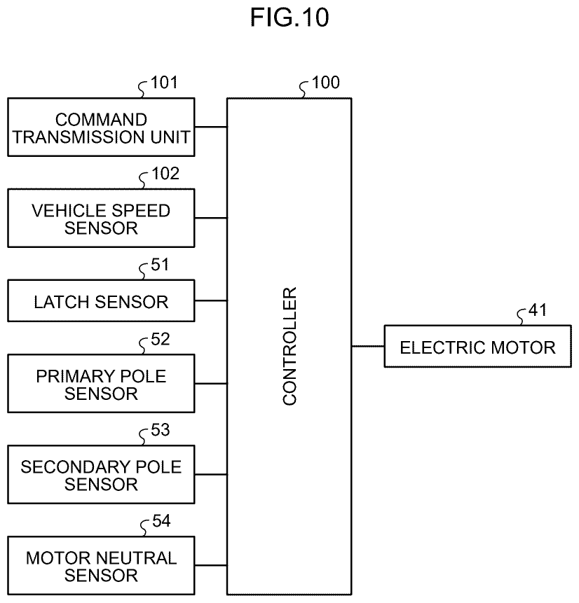

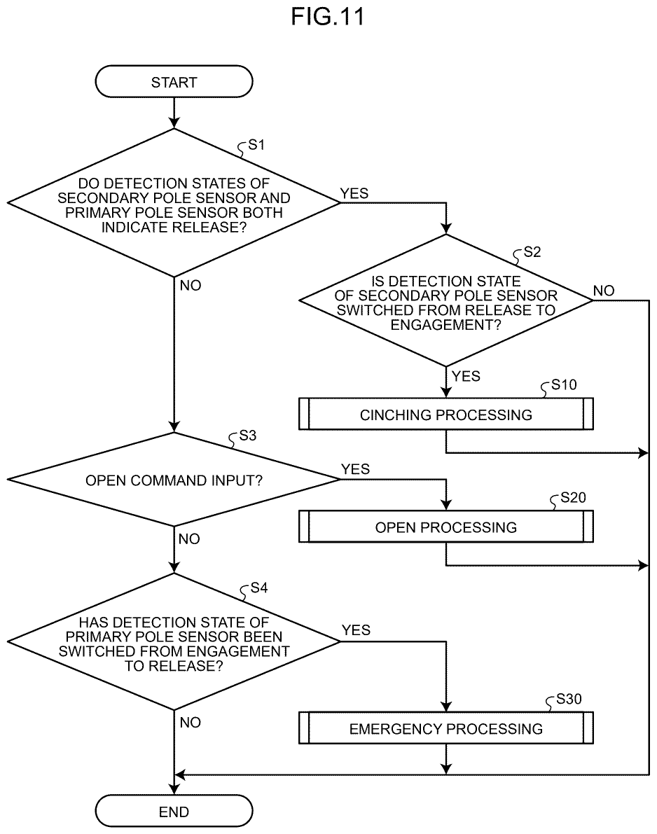

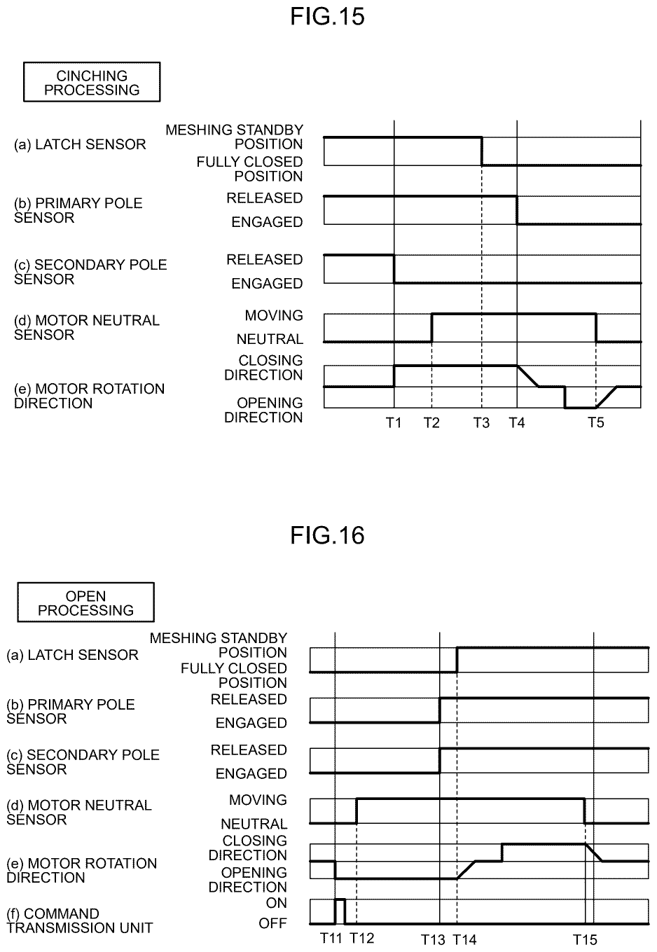

FIG. 10 is a diagram illustrating a control system of the front hood latch device 1. The controller 100 illustrated in FIG. 10 controls the driving of the electric motor 41 in accordance with a program or data stored in a memory in a case where an output signal is given from a command transmission unit 101, a vehicle speed sensor 102, the latch sensor 51, the primary pole sensor 52, the secondary pole sensor 53, or the motor neutral sensor 54. The command transmission unit 101 is for outputting an open command to the controller 100 at the time of opening the frunk FT, and examples of the command transmission unit 101 include a key FOB carried by the owner of the vehicle or a front hood open switch included in the vehicle interior. The vehicle speed sensor 102 detects the speed of the vehicle and outputs the detection result to the controller 100. The controller 100 may be implemented by, for example, causing a processing device such as a CPU to execute a program, namely, by software, may be implemented by hardware such as an IC, or can be implemented by using software and hardware in combination. Hereinafter, the processing content of the controller 100 will be described in detail with reference to flowcharts illustrated in FIGS. 11 to 14 and timing charts illustrated in FIGS. 15 and 16 as appropriate.

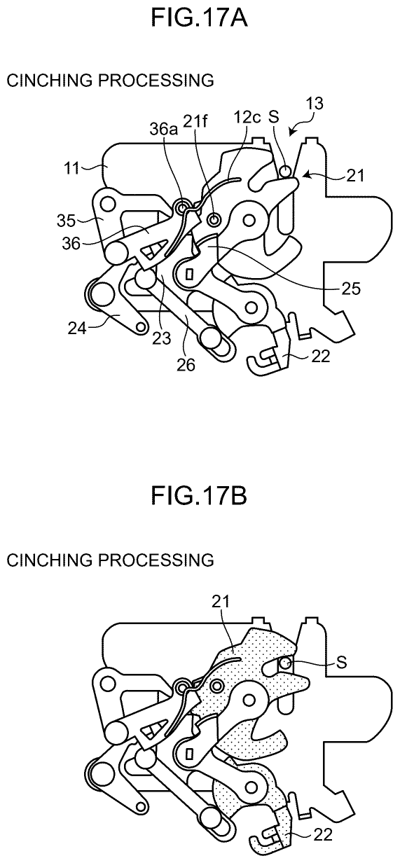

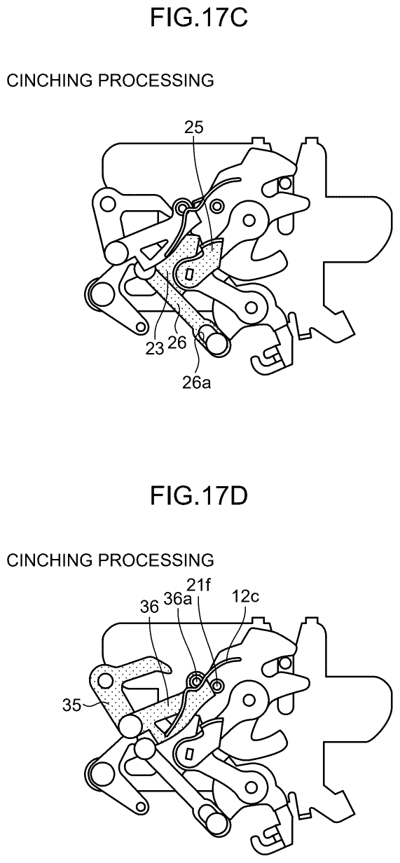

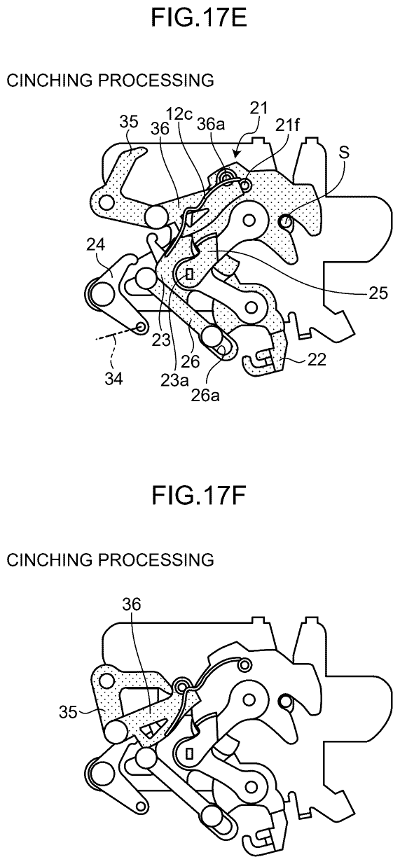

As illustrated in FIG. 3, it is based on the premise that the front hood FP is disposed at a position where the opening of the frunk FT is opened. At this point, as illustrated in FIG. 17A, the latch 21 of the front hood latch device 1 is positioned in the meshing standby state by the latch spring 21e, the open lever 35 is disposed at the neutral position, and the emergency lever 24 is disposed at the operation standby position. As described above, the primary pole 22 and the secondary pole 23 are energized in the engagement direction in a state of each abutting against the outer peripheral surface of the latch 21 with the primary spring 22b and the secondary spring 23b, respectively.

### Close Operation of Front Hood FP

Operating the front hood FP in such a manner as to close the opening of the frunk FT from the above-described state while the vehicle is stopped allows the striker S to enter the striker approach groove 13, whereby the striker S abuts on the striker abutment portion 21b of the latch 21 as illustrated in FIGS. 17B and 17C. When the front hood FP is further moved in the same direction from this state, the latch 21 rotates in the meshing direction against the urging force of the latch spring 21e, and the front hood FP eventually reaches the fully closed position where the opening of the frunk FT is completely closed. At this point, in the front hood latch device 1, when the latch 21 is disposed in the primary latch position, the primary pole 22 is engaged with the latch 21, whereby the movement in the release direction is prevented. As a result, the front hood FP is maintained at the fully closed position where the frunk FT is closed.

### Cinching Processing

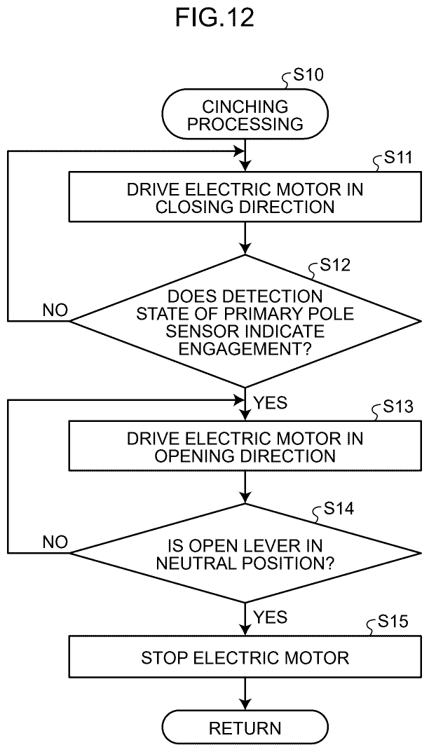

In a case where the front hood FP in the opened state is moved to close halfway to be disposed at the half-hooked position, the latch 21 is disposed at the secondary latch position, and the secondary pole 23 is engaged with the latch 21, whereby movement in the release direction is prevented. As a result, even in a case where the operation force on the front hood FP is removed, the front hood FP is maintained at a slightly opened position with respect to the frunk FT. If it is detected that the latch 21 has moved from the meshing standby state to the secondary latch position with the detection state of the secondary pole sensor 53 switched, the controller 100 performs the cinching processing (step S1=Yes->step S2 =Yes->step S10 in FIG. 11) and drives the electric motor 41 in the closing direction (step S11 in FIG. 12: T1 in FIG. 15). As a result, as illustrated in FIG. 17D, the open lever 35 rotates in the cinching direction (T2 in FIG. 15), and the rotation of the open lever 35 progresses in a state where the cinching lever 36 abuts on the latch pin 21f. Therefore, the cinching lever 36 moves along the guide rib 12c via the guide pin 36b, and the latch 21 is disposed at the primary latch position. As a result, as illustrated in FIG. 17E, the primary pole 22 is engaged with the latch 21, which prevents movement in the release direction, and thus the front hood FP is maintained at the fully closed position where the frunk FT is closed (T3 in FIG. 15). If it is detected that the latch 21 is disposed at the primary position by the primary pole sensor 52 (step S12=Yes in FIG. 12: T4 to T5 in FIG. 15), the controller 100 drives the electric motor 41 in the opening direction until the open lever 35 returns to the neutral position as illustrated in FIG. 17F (steps S13 to S15 in FIG. 12).

In this manner, operation to close the front hood FP from the opened state to the half-hooked position allows the front hood latch device 1 to move to a position where the frunk FT is completely closed, which is advantageous in terms of operability. Moreover, the cinching lever 36 is rotatably supported by the cinching connection portion 35b of the open lever 35, and is moved along the guide rib 12c included in the case 12. Therefore, there is also an advantage that the force or the path for introducing the striker S can be easily adjusted by modifying the extending length from the cinching connection portion 35b or the path of the guide rib 12c as appropriate. In addition, since the cinching lever 36 is disposed in such a manner as to overlap the latch 21 in the direction along the latch shaft 21a, transmission loss can be reduced.

### Open Processing of Front Hood FP by Operation of Command Transmission Unit 101

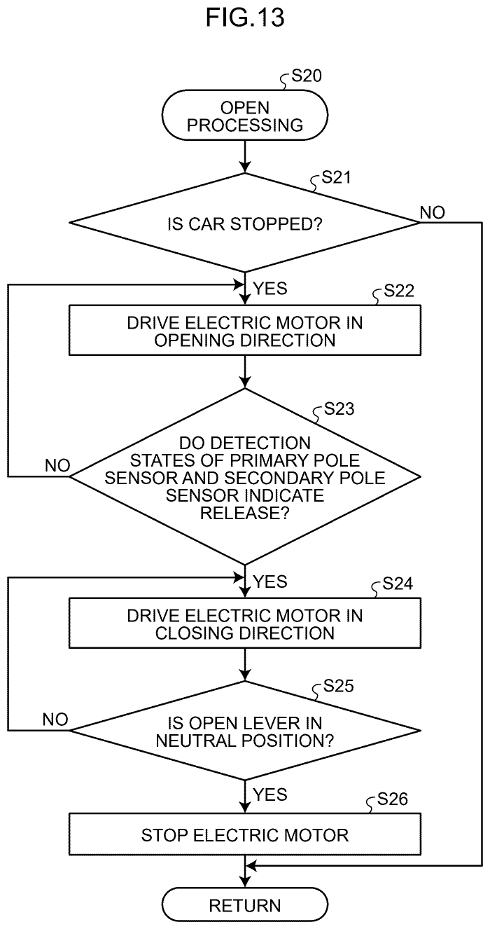

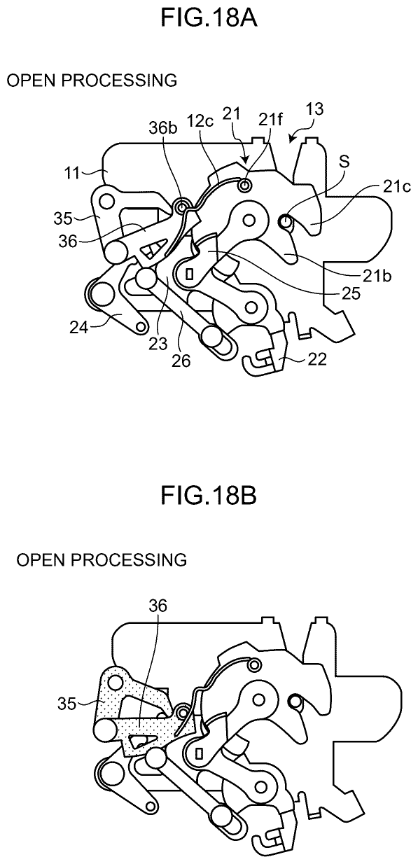

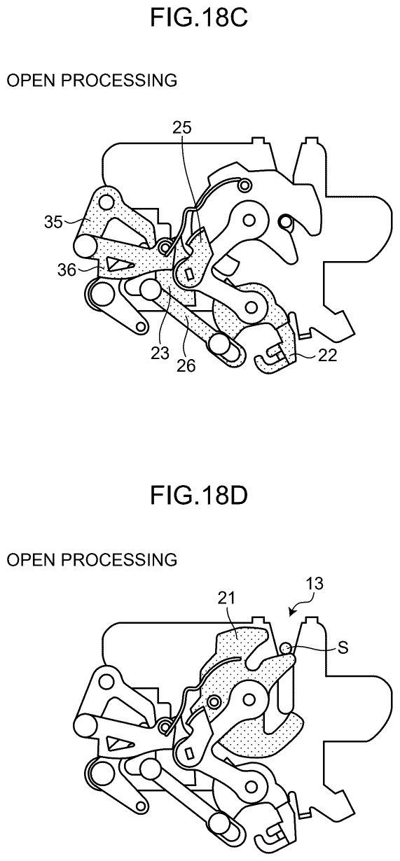

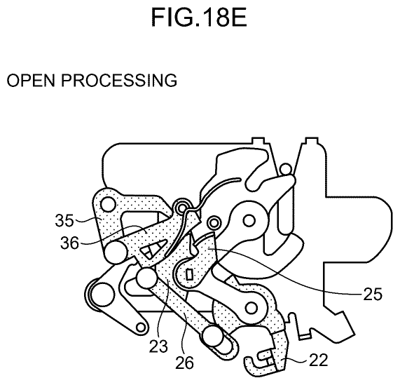

As illustrated in FIG. 18A, when the command transmission unit 101 is operated in a state where the latch 21 meshed with the striker S is at the primary latch position and the opening of the frunk FT is closed by the front hood FP (T11 in FIG. 16), the controller 100, which has detected that an open command has been given, performs open processing (step S1=No->step S3=Yes->step S20 in FIG. 11), determines whether or not the vehicle is traveling through the vehicle speed sensor 102, and drives the electric motor 41 in the opening direction on condition that the vehicle is stopped (step S21=Yes->step S22 in FIG. 13). As a result, as illustrated in FIG. 18B, the open lever 35 rotates in the release direction (T12 in FIG. 16), and as illustrated in FIG. 18C, the secondary pole 23 rotates in the direction of releasing the engagement state with the latch 21, and the rotation of the secondary pole 23 is transmitted to the primary pole 22 via the link bar 26 and rotates in the release direction until the engagement state with the latch 21 is released (T13 in FIG. 16). As a result, as illustrated in FIG. 18D, there is an advantage that the front hood FP can be opened and the frunk FT can be opened only by operating the command transmission unit 101 once, which can facilitate placing or taking luggage to or from the frunk FT. Note that the operation described above works similarly even if the open command is output from the command transmission unit 101 in a case where the latch 21 engaged with the striker S is at the secondary latch position, and driving the electric motor 41 in the opening direction on condition that the vehicle is not traveling causes the front hood FP to be opened to open the frunk FT. If it is detected that the latch 21 is disposed in the meshing standby state with the latch sensor 51, the primary pole sensor 52, and the secondary pole sensor 53 switched (step S23=Yes in FIG. 13: T13 to T14 in FIG. 16), the controller 100 drives the electric motor 41 in the closing direction until the open lever 35 returns to the neutral position as illustrated in FIG. 18E (steps S24 to S26 in FIG. 13).

On the other hand, if it is determined that the vehicle is traveling when the open command is output from the command transmission unit 101 (step S21=No in FIG. 13), the controller 100 maintains the open lever 35 at the neutral position without driving the electric motor 41. Therefore, even in a case where the command transmission unit 101 is erroneously operated while the vehicle is traveling, there is no possibility that the front hood FP is inadvertently brought into the fully opened state, nor is there a possibility of bringing about problems such as blocking the forward view by the front hood FP during traveling.

### Open Processing of Front Hood FP by Operation of In-Vehicle Operation Unit 33

When the latch 21 meshed with the striker S is in the primary latch position and the in-vehicle operation unit 33 is operated in a state where the opening of the frunk FT is closed by the front hood FP, the operation force is transmitted to the secondary pole 23 via the emergency cable 34 and the emergency lever 24, the secondary pole 23 rotates in a direction of releasing the engagement state with the latch 21, and the rotation of the secondary pole 23 is transmitted to the primary pole 22 via the link bar 26, whereby the primary pole 22 rotates in a direction of releasing the engagement state with the latch 21. As a result, there is an advantage that the front hood FP can be opened and the frunk FT can be opened only by operating the in-vehicle operation unit 33 once, which can facilitate placing or taking luggage to or from the frunk FT. Note that the above operation similarly works even in a case where the in-vehicle operation unit 33 is operated when the latch 21 engaged with the striker S is at the secondary latch position, and the front hood FP can be opened to open the frunk FT.

As described above, the in-vehicle operation unit 33 is provided at a position where operation is not possible in a state where the vehicle is traveling, such as at the back on the floor of the driver's seat. Therefore, there is no possibility that the front hood FP is inadvertently brought into the fully opened state, nor is there a possibility of bringing about problems such as blocking the forward view by the front hood FP during traveling.

In addition, even after the latch 21 moves to the primary latch position, the cinching lever 36 and the latch pin 21f, for example, adhere to each other at the time of the above-described cinching processing, which hinders the open lever 35 from returning to the neutral position, and the cinching lever 36 stops in a state where the latch 21 is disposed at the primary position or the secondary position. This may cause a situation in which the front hood FP cannot be opened. In addition, also in cases where a gear in the deceleration mechanism is fixed or the power of a battery is insufficient, the open lever 35 may not return to the neutral position. In such a case, operating the in-vehicle operation unit 33 allows the operation force to be transmitted to the cancel lever 25 via the emergency cable 34, the emergency lever 24, the secondary pole 23, and the secondary shaft 23a as illustrated in FIG. 17E, the cinching lever 36 rotates counterclockwise in the drawing with the cancel lever 25 abutting there against, whereby the abutting state with the latch pin 21f is released. As a result, the latch 21 can rotate in the opening direction, which allows the front hood FP to be opened. As a result, once an open command is output from the command transmission unit 101, the electric motor 41 rotates in the opening direction again, whereby the front hood FP can be opened to open the frunk FT. Since the cancel lever 25 is provided in such a manner as to rotate integrally with the secondary shaft 23a, there is no possibility of hindering the engagement or release operation of the primary pole 22 or the secondary pole 23 with respect to the latch 21.

### Open Processing of Front Hood FP by Operation of In-Frunk Operation Unit 31)

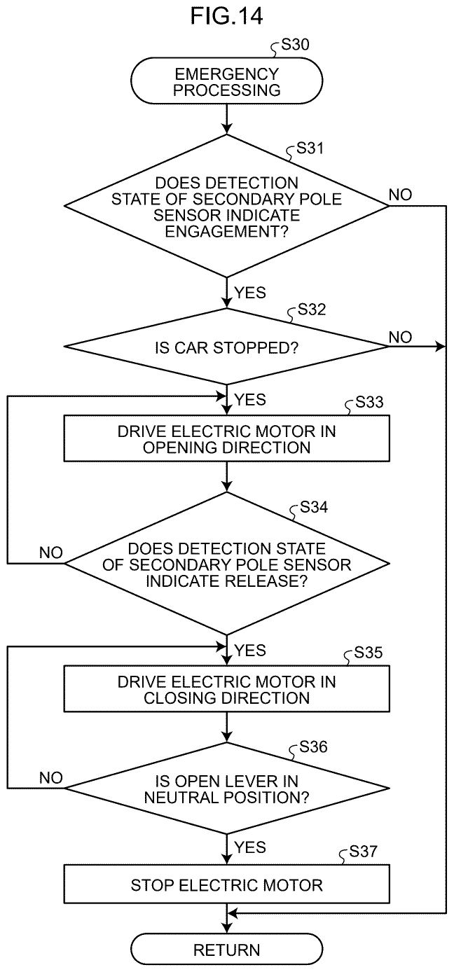

When the in-frunk operation unit 31 is operated in a state where the latch 21 meshed with the striker S is in the primary latch position and the opening of the frunk FT is closed by the front hood FP, the operation force is transmitted to the primary pole 22 via the frunk cable 32, whereby the primary pole 22 rotates in the direction of releasing the engagement state with the latch 21 (step S4=Yes in FIG. 11). At this point, the rotation of the primary pole 22 is absorbed by the long hole 26a of the link bar 26 and is not transmitted to the secondary pole 23. As a result, the secondary pole 23 is engaged in a state where the latch 21 has rotated to the secondary latch position, and the front hood FP is maintained at the half-hooked position (step S31=Yes in FIG. 14).

At this point, in a case where the latch 21 is disposed from the primary latch position to the secondary latch position by the operation of the in-frunk operation unit 31, the secondary pole 23 is not switched from the engagement state. Therefore, the controller 100 determines whether or not the vehicle is traveling through the vehicle speed sensor 102 without starting the above-described cinching processing (step S32) and drives the electric motor 41 in the opening direction on condition that the vehicle is stopped (step S32=Yes->step S33). As a result, the open lever 35 rotates in the release direction, and the secondary pole 23 rotates in the release direction until the engagement state with the latch 21 is released.

Therefore, only by operating the in-frunk operation unit 31 once, the front hood FP is opened and the frunk FT is opened, and for example, even if a situation occurs in which the front hood FP is closed in a state where a person is in the frunk FT, the person can easily escape. If it is detected that the latch 21 is disposed in the meshing standby state by the secondary pole sensor 53, the controller 100 drives the electric motor 41 in the closing direction until the open lever 35 returns to the neutral position (steps S34 to S37 in FIG. 14).

On the other hand, if it is determined that the vehicle is traveling at the time when it has been detected that the latch 21 has been arranged from the primary latch position to the secondary latch position by operation of the in-frunk operation unit 31, the controller 100 maintains the open lever 35 at the neutral position without driving the electric motor 41 (step S32=No). Therefore, even in a case where the in-frunk operation unit 31 is operated while the vehicle is traveling, there is no possibility that the front hood FP is inadvertently brought into the fully opened state, nor is there a possibility of bringing about problems such as blocking the forward view by the front hood FP during traveling. Note that the front hood FP moves to the half-hooked position while the vehicle is traveling, and it is possible to recognize occurrence of an abnormal situation such as that the front hood FP is closed in a state where a person is in the frunk FT.

According to the front hood latch device 1 described above, operating the command transmission unit 101 once can open the front hood FP to the fully opened state. Similarly, operating the in-vehicle operation unit 33 or the in-frunk operation unit 31 can also open the front hood FP to the fully opened state at a time. Therefore, the operability of the frunk FT can be improved, which is advantageous in terms of usability. In addition, when the vehicle is traveling, there is no possibility that the front hood FP is inadvertently brought into the fully opened state, and there are no issues in traveling safety of the vehicle. In addition, since the circuit board 50 is disposed at a position overlapping the latch 21, the primary pole 22, and the secondary pole 23 in the axial direction of the latch shaft 21a, and the magnet sensors 51, 52, 53, and 54 are provided at positions where the latch detection magnet 21g, the primary detection magnet 22f, the secondary detection magnet 23f, and the open lever detection magnet 35c are detected, not only miniaturization can be achieved, but also it is not necessary to provide individual detection switches, whereby the assembly work can also be facilitated. Furthermore, since the electric motor 41 for rotating the latch 21 in the opening direction is also used as a drive source for cinching, it is possible to suppress an increase in size of the device and an increase in the manufacturing cost. Furthermore, since the in-vehicle operation unit 33 is included, even in a case where the power of the battery is insufficient, it is possible to open the front hood FP to open the frunk FT by manual operation on condition that the vehicle is stopped, which can prevent impairing the convenience.

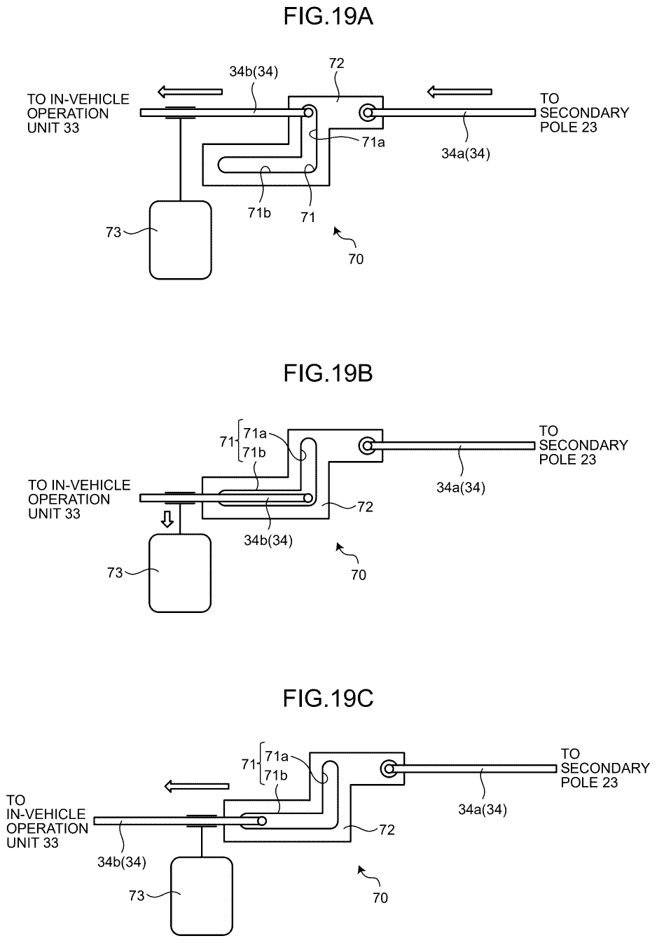

The in-vehicle operation unit 33 is provided at the back of the driver's seat to make it impossible to operate the in-vehicle operation unit 33 while the vehicle is traveling; however, as in a modification illustrated in FIG. 19, for example, a transmission switch unit 70 operated by an actuator may be interposed in the middle of the emergency cable 34. That is, in the modification illustrated in FIG. 19, a plate 72 having a crank groove 71 is interposed in the middle of the emergency cable 34, and an end of a portion of the emergency cable 34 leading to the secondary pole 23 (hereinafter, referred to as the driven-side cable 34a) is coupled to the plate 72, whereas an end of a portion of the emergency cable 34 leading to the in-vehicle operation unit 33 (hereinafter, referred to as the driving-side cable 34b) is connected in such a manner as to be movable inside the crank groove 71. The crank groove 71 includes a power transmission groove 71a extending in a direction orthogonal to the emergency cable 34 and a power non-transmission groove 71b extending from the power transmission groove 71a along the emergency cable 34. A shift actuator 73 for changing the position of the end with respect to the crank groove 71 is linked to the driving-side cable 34b.

In this modification, in the case where the vehicle is stopped, the shift actuator 73 is operated by the controller 100, and the end of the driving-side cable 34b is disposed in the power transmission groove 71a of the crank groove 71 as illustrated in FIG. 19A. Therefore, in a case where the in-vehicle operation unit 33 is operated from this state, the driven-side cable 34a operates via the plate 72, and the secondary pole 23 rotates in the direction of releasing the engagement state with the latch 21.

Meanwhile, in a case where the vehicle is traveling, the shift actuator 73 is operated by the controller 100 as illustrated in FIG. 19B, and the end of the driving-side cable 34b is disposed in the power non-transmission groove 71b of the crank groove 71. Therefore, even in a case where the in-vehicle operation unit 33 is operated from this state, as illustrated in FIG. 19C, the driven-side cable 34a does not operate, and the secondary pole 23 is maintained in the state of being engaged with the latch 21.

In the above-described embodiment, the speed of the vehicle is detected by the vehicle speed sensor; however, the gear position of the transmission may be detected in addition to the speed of the vehicle, whereby it may be determined as being in the traveling state in a case where the transmission is not in the parking position even when the vehicle speed is zero. As a result, it is possible to prevent a situation in which, for example, the front hood is unintentionally opened when the vehicle is stopped at a traffic light.

In addition, in the above-described embodiment, in a case where the electric motor 41 operates in the opening direction, the secondary pole 23 is operated in the release direction, and the primary pole 22 is operated in the release direction via the link bar 26 provided between the secondary pole 23 and the primary pole 22. However, it is not always necessary to cause the primary pole 22 to operate in the release direction via the secondary pole 23 and the link bar 26. For example, it is also possible to cause the secondary pole to operate in the release direction until the operating angle of the actuator unit in the opening direction reaches a predetermined threshold and to cause the primary pole to operate in the release direction in a case where the operating angle of the actuator unit in the opening direction exceeds the threshold.

Furthermore, in the above-described embodiment, the primary pole is interlocked in the case where the secondary pole moves in the release direction; however, the secondary pole may be interlocked in a case where the primary pole moves in the release direction.

### REFERENCE SIGNS LIST

1 FRONT HOOD LATCH DEVICE
10 HOUSING MEMBER
11 BASE PLATE (HOUSING MEMBER)
11a SURFACE
12 CASE (HOUSING MEMBER)
12a INNER SURFACE
12b OUTER SURFACE
12c GUIDE RIB
13 STRIKER APPROACH GROOVE
14 COVER (HOUSING MEMBER)
21 LATCH
21a LATCH SHAFT
21b STRIKER ABUTMENT PORTION
21c HOOK PORTION
21d ACCOMMODATION GROOVE
21e LATCH SPRING
21f LATCH PIN
21g LATCH DETECTION MAGNET
21h CASE FACING SURFACE
21j PRIMARY ENGAGEMENT PORTION
21k SECONDARY ENGAGEMENT PORTION
22 PRIMARY POLE
22a PRIMARY SHAFT
22b PRIMARY SPRING
22c FRUNK CABLE CONNECTION PORTION
22d LEVER LINK PORTION
22e CASE FACING SURFACE
22f PRIMARY DETECTION MAGNET
23 SECONDARY POLE
23a SECONDARY SHAFT
23b SECONDARY SPRING
23c ACTUATOR INPUT PORTION
23d LEVER LINK PORTION
23e CASE FACING SURFACE
23f SECONDARY DETECTION MAGNET
24 EMERGENCY LEVER
24a EMERGENCY SUPPORT SHAFT
24b POLE PRESSING PORTION
24c CABIN CABLE CONNECTION PORTION
24d LEVER SPRING
25 CANCEL LEVER
26 LINK BAR (INTERLOCKING LINK UNIT)
26a LONG HOLE
31 IN-FRUNK OPERATION UNIT
32 FRUNK CABLE
33 IN-VEHICLE OPERATION UNIT
34 EMERGENCY CABLE
34a DRIVEN-SIDE CABLE
34b DRIVING-SIDE CABLE
35 OPEN LEVER
35a PRESSING LEVER PORTION
35b CINCHING CONNECTION PORTION
35c OPEN LEVER DETECTION MAGNET
36 CINCHING LEVER (CLOSE OPERATION TRANSMISSION UNIT)
36a CINCHING SUPPORT SHAFT
36b GUIDE PIN
40 ACTUATOR UNIT
41 ELECTRIC MOTOR
41a OUTPUT SHAFT
42 WORM GEAR
43 FIRST GEAR
43a, 45a SUPPORT SHAFT
44 SECOND GEAR
45 THIRD GEAR
46 FOURTH GEAR
47 SECTOR GEAR
47a BOSS PORTION
50 CIRCUIT BOARD
51 LATCH SENSOR
52 PRIMARY POLE SENSOR
53 SECONDARY POLE SENSOR
54 MOTOR NEUTRAL SENSOR
70 TRANSMISSION SWITCH UNIT
71 CRANK GROOVE
71a POWER TRANSMISSION GROOVE
71b POWER NON-TRANSMISSION GROOVE
72 PLATE
73 SHIFT ACTUATOR
100 CONTROLLER
101 COMMAND TRANSMISSION UNIT
102 VEHICLE SPEED SENSOR
B VEHICLE BODY
FP FRONT HOOD
FT FRUNK
FW FRONT WHEEL
S STRIKER

1. A front hood latch device comprising:
a latch provided in a body of a vehicle, the latch meshable with a striker at a front portion of a front hood when the front hood is closed;
an energizing member that energizes the latch in a direction of releasing the meshing;
a primary pole that maintains the front hood in a fully closed position by being engaged with the latch in a state where the latch engaged with the striker is disposed in a predetermined primary latch position;
a secondary pole that maintains the front hood at a half-hooked position by being engaged with the latch in a case where the latch released from an engagement state with the primary pole is disposed at a predetermined secondary latch position; and
an actuator unit capable of releasing the engagement state between the primary pole and the latch when the actuator unit operates in an opening direction,
wherein the actuator unit is operated in the opening direction in a case where an open command is given while the vehicle is stopped, and the actuator unit is maintained in a halted state in a case where an open command is given while the vehicle is traveling.

2. The front hood latch device according to claim 1, further comprising:
an in-front trunk operation transmission unit that causes the primary pole to operate in a direction of releasing the engagement state with the latch in a case where an in-front trunk operation unit is operated, the in-front trunk operation unit provided inside the front trunk that can be opened and closed by the front hood,
wherein, in the case where the primary pole operates in the direction of releasing the engagement state with the latch, the secondary pole is caused to operate in a direction of releasing the engagement state with the latch on condition that the vehicle is stopped.

3. The front hood latch device according to claim 1, further comprising an in-vehicle operation transmission unit that causes the secondary pole to operate in the direction of releasing the engagement state with the latch in a case where an in-vehicle operation unit provided in a cabin is operated, wherein the in-vehicle operation unit is provided at a position where it cannot be operated in a state where the vehicle is traveling.

4. The front hood latch device according to claim 1, further comprising: an in-vehicle operation transmission unit that causes the secondary pole to operate in the direction of releasing the engagement state with the latch in a case where an in-vehicle operation unit provided in a cabin is operated, wherein the in-vehicle operation transmission unit has a transmission switch unit that switches between an ON state in which an operation of the in-vehicle operation unit can be transmitted to the secondary pole and an OFF state in which an operation of the in-vehicle operation unit cannot be transmitted to the secondary pole, and the transmission switch unit enters the ON state only in a case where the vehicle is not traveling.

5. The front hood latch device according to claim 1, further comprising a close operation transmission unit that causes the latch to operate toward a primary latch position in a case where the actuator unit operates in a closing direction in a state where the latch is disposed in the secondary latch position.

6. The front hood latch device according to claim 5, wherein the actuator unit is caused to operate in the closing direction on condition that the latch is disposed in the secondary latch position by moving in the closing direction from a state in which the front hood is opened and that the secondary pole is engaged with the latch.

7. The front hood latch device according to claim 1, wherein an interlocking link unit is provided between the primary pole and the secondary pole, the interlocking link unit interlocking either the primary pole or the secondary pole in a case where the other one operates in the direction of releasing the engagement with the latch.

8. The front hood latch device according to claim 7,
wherein the interlocking link unit comprises a link bar that interlocks the primary pole and the secondary pole, and
the link bar interlocks the primary pole to move in the direction of releasing the engagement state with the latch in a case where the secondary pole operates in the direction of releasing the engagement state with the latch and, in a case where the primary pole operates in the direction of releasing the engagement state with the latch, maintains the secondary pole in a state of being engaged with the latch.

9. The front hood latch device according to claim 8, further comprising an open operation transmission unit that causes the secondary pole to operate in the direction of releasing the engagement state with the latch in a case where the actuator unit operates in the opening direction.

10. The front hood latch device according to claim 5, wherein a housing member accommodating the latch includes a guide portion along a movement path of the close operation transmission unit.

11. The front hood latch device according to claim 10, further comprising a cancel unit that releases the engagement state between the close operation transmission unit and the latch in a case where an operation force for emergency use is input.

12. The front hood latch device according to claim 11, wherein the cancel unit includes a cancel lever that operates integrally with the secondary pole.

13. The front hood latch device according to claim 9,
wherein the actuator unit comprises a drive source and a deceleration mechanism,
the deceleration mechanism is disposed at a position where at least a component overlaps the latch in an operation axis direction of the latch,
an output unit of the drive source and an output unit of the deceleration mechanism are arranged at positions around the latch in the operation axis direction of the latch,
a circuit board on which a controller for controlling an operation of the actuator unit is mounted is disposed between the output unit of the drive source and the output unit of the deceleration mechanism in an operation axis direction of the latch and at a position overlapping the latch, the primary pole, and the secondary pole, and
the circuit board is provided with a state detection sensor that detects states of the latch, the primary pole, and the secondary pole.
